(19) United States
(12) Patent Application Publication
(10) Pub. No.: US 2015/0151689 A1
(43) Pub. Date: Jun. 4, 2015

(54) VEHICULAR VIDEO CONTROL APPARATUS

(71) Applicant: DENSO CORPORATION, Kariya-city, Aichi-pref. (JP)

(72) Inventors: Takeshi Kimura, Kariya-city (JP); Masakazu Itou, Anjo-city (JP)

(21) Appl. No.: 14/413,874

(22) PCT Filed: Jul. 18, 2013
(86) PCT No.: PCT/JP2013/004391

§ 371 Date: Jan. 9, 2015

(30) Foreign Application Priority Data
Jul. 20, 2012 (JP) 2012-161622

(51) Int. Cl. B60R 11/02; G06F 3/14

(52) U.S. Cl. CPC B60R 11/02; G06F 3/14

(57) ABSTRACT

A display controller has an output arbitration function for distributively outputting a plurality of different interrupt screens compliant with display requests from a plurality of parallelly-running applications to a plurality of display units mounted in a vehicle. In such an instance, the display controller acquires output destination priorities of the display units to which the interrupt screens are output and screen priorities defined for the interrupt screens. In accordance with the screen priorities of the individual interrupt screens compliant with the display requests and in accordance with the associated output destination priorities, the display controller selects appropriate display units and outputs the individual interrupt screens to the selected display units.

### CROSS REFERENCE TO RELATED APPLICATION

The present disclosure is based on Japanese Patent Application No. 2012-161622 filed on Jul. 20, 2012, the disclosure of which is incorporated herein by reference.

### TECHNICAL FIELD

The present disclosure relates to a vehicular video control apparatus that controls display outputs of applications running in a vehicle-mounted instrument.

### BACKGROUND ART

A plurality of different applications, such as an audio/visual application and a navigation application, can be conventionally operated in a vehicle-mounted instrument that generates a display output and an audio output to a user. A technology for controlling display outputs from a plurality of applications is disclosed, for instance, in Patent Literature 1.

According to the technology described in Patent Literature 1, a means to adjust the content of outputs when output requests are generated from a plurality of applications is defined as described below. The contents of outputs of all applications are described in a table that is prepared to predetermine an output to be delivered, the destination of the output, and how the output is to be delivered. When output requests are generated from a plurality of applications, output resources are distributed in accordance with the table to adjust the contents of outputs.

### PRIOR ART LITERATURES

### Patent Literature

Patent Literature 1: JP 2007-145137 A

A method of combining data displayed by two applications into a single screen is disclosed in Patent Literature 1. Patent Literature, however, does not disclose a display control to be exercised over an application's interrupt screen (a screen that opens irregularly and suddenly in an emergency or under other specific conditions) in a situation where a plurality of display units are used.

A conventional technology predetermines only one display destination for an interrupt screen output from an application so that the display destination for the interrupt screen cannot be changed flexibly depending on the situation. If display requests for outputting respective interrupt screens to a particular display unit are simultaneously generated from a plurality of applications, the output destination is not permitted to be changed for a subject interrupt screen that cannot be displayed on the particular display unit and the subject interrupt screen is thus not permitted to be displayed on another display unit. Even if a display unit different from the particular display unit is unoccupied, only one of a plurality of interrupt screens can be displayed on the particular display unit. This may result in the loss of an opportunity to present information to the user.

### SUMMARY OF INVENTION

It is an object of the present disclosure to properly process interrupt screen display requests from a plurality of applications in a vehicle-mounted system having a plurality of display units.

To achieve the above object, according to an aspect of the present disclosure, a vehicular video control apparatus is provided to include an output instruction section, an output destination priority acquisition section, and a screen priority acquisition section. The output instruction section distributively outputs a plurality of different interrupt screens compliant with display requests from a plurality of parallelly-running applications to a plurality of video display units mounted in a vehicle. The output destination priority acquisition section acquires output destination priorities indicative of priorities of the plurality of video display units selectable as output destinations for the interrupt screens. The screen priority acquisition section acquires screen priorities indicative of display priorities defined for the interrupt screens.

In particular, in accordance with the output destination priorities determined by the output destination priorities of the interrupt screens compliant with the display requests and in accordance with the screen priorities of the interrupt screens, the output instruction section selects the video display units as the output destinations for the interrupt screens and outputs the interrupt screens to the selected video display units.

According the above-described configuration, an output destination for an application's interrupt screen can be flexibly selected from a plurality of video display units, which are output destination candidates. Thus, no specific display unit needs to be predetermined as the output destination. In this instance, output destinations for displaying a plurality of interrupt screens are methodically determined in accordance with output destination priorities and screen priorities defined for the individual interrupt screens. If, for example, a plurality of interrupt screen display requests are generated with respect to a particular video display unit, an interrupt screen having the highest screen priority may be displayed on the particular video display unit. In addition, the output destination for an interrupt screen having a low screen priority may be changed to a video display unit having a low output destination priority. Adopting the above-described scheme can avoid the loss of an opportunity to present information to the user even when a plurality of interrupt screen display requests are generated with respect to the same video display unit.

### BRIEF DESCRIPTION OF DRAWINGS

The above and other objects, features and advantages of the present disclosure will become more apparent from the following detailed description made with reference to the accompanying drawings. In the drawings:

FIG. 1A is a schematic block diagram illustrating a configuration of a control apparatus, and FIG. 1B is a block diagram illustrating a configuration of a software system;

FIG. 2 is a flowchart illustrating a sequence of an interrupt screen display process;

FIG. 3A shows an example of interrupt screen presenting information, and FIG. 3B shows a reference example of a display rule that is applied when no improvement is made; and

FIG. 4A shows exemplary screen transitions, and FIG. 4B shows exemplary screen transitions when no improvement is made.

### EMBODIMENTS FOR CARRYING OUT INVENTION

An embodiment of the present disclosure will now be described with reference to the accompanying drawings. The present disclosure is not limited to the embodiment described below and may be variously modified.

[Description of Configuration of Control Apparatus 10]

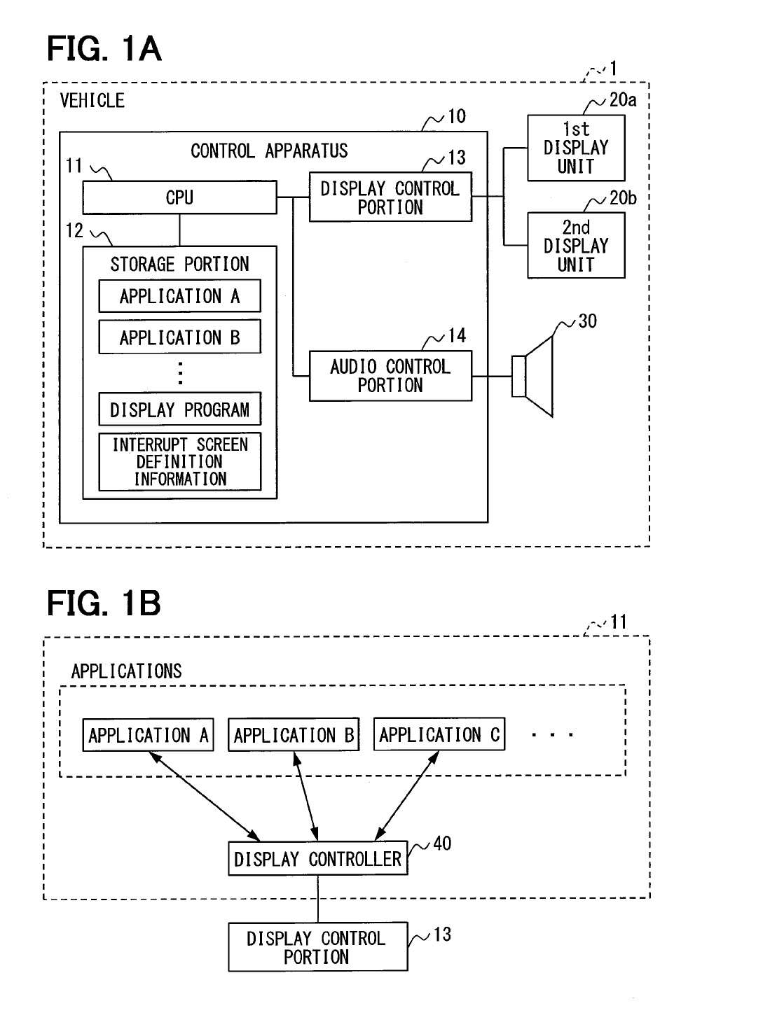

A control apparatus 10 according to an embodiment of the present disclosure is a core apparatus of an audio/video system mounted in a vehicle 1. It is embodied, for example, by a one-piece audio/visual (AV) navigation apparatus. As shown in FIG. 1A, the control apparatus 10 includes a CPU 11, a storage portion 12, a display control portion 13, and an audio control portion 14. The display control portion 13 is connected to two display units 20a, 20b, which are disposed in the vehicle 1. The display units are also referred to as video display units or video display means. When the two display units are to be distinguished from each other, they are referred to as a first display unit (20a) and a second display unit (20b). The audio control portion 14 is connected to a speaker 30 disposed in the vehicle 1.

The CPU 11 is an arithmetic processing unit that provides integrated control of all components of the control apparatus 10 in accordance with a program. The CPU 11 performs various application processes in accordance with an application program and data read from the storage portion 12. The CPU 11 runs various applications such as a navigation application, a clearance sonar application, a hands-free phone call application, and a menu application. These applications are merely examples. The other applications may be implemented. The CPU 11 executes a display controller program that performs arbitration to determine output destinations for interrupt screens compliant with display requests generated from the applications.

The navigation application provides route guidance for the vehicle and executes a map display function, a route search function, a route guidance function, and other functions. The map display function is executed to display, for example, a map showing an area around the current location or a mark indicative of the current location of the vehicle. The route search function is executed to automatically calculate an optimal route from the current location to a destination. The route guidance function is executed to provide travel guidance along the route determined by the route search function. An image generated by the navigation application appears on a predetermined display unit through the display control portion 13. A guidance voice output is additionally used for travel guidance. A guidance voice is output from the speaker 30 through the audio control portion 14.

The clearance sonar application uses a sonar attached to the body of the vehicle to detect an approaching obstacle and audibly and visually notifies a driver of the vehicle 1 of the approaching obstacle. When the sonar attached to the front or rear of the vehicle body detects an approaching obstacle that might come into contact with the vehicle 1, the clearance sonar application generates a warning-related interrupt screen display request to notify the driver of the approaching obstacle. An interrupt image (or an interrupt screen) compliant with the display request from the clearance sonar application is displayed on the first display unit 20a or on the second display unit 20b after arbitration is performed between the above-mentioned display request and another application's interrupt image (or interrupt screen) display request.

The hands-free phone call application provides a hands-free phone call function that is executed in the vehicle 1 by a mobile phone. When there is an incoming phone call from the outside, the hands-free phone call application generates an interrupt screen display request to notify the driver of the incoming phone call. An interrupt image compliant with the display request from the hands-free phone call application is displayed on the first display unit 20a or on the second display unit 20b after arbitration is performed between the above-mentioned display request and another application's interrupt image display request.

The menu application displays a menu screen from which various manipulation items are selectable. The menu application displays the menu screen on a predetermined display unit to present a list of manipulation items for manipulating various vehicle-mounted instruments.

The storage portion 12 is a storage apparatus embodied, for instance, by a hard disk drive or a rewritable nonvolatile semiconductor memory. The storage portion 12 stores a system program executed by the CPU 1 to operate the control apparatus 10, application programs, a display control program, and various data such as interrupt screen definition information. The application programs for, for example, the above-described navigation application, clearance sonar application, hands-free phone call application, and menu application are also stored in the storage portion 12.

The display control portion 13 is a display output interface unit that displays an image by distributing a display output signal from a plurality of applications executed by the CPU 11 to the first display unit 20a and the second display unit 20b. The audio control portion 14 is an audio output interface unit that outputs audio by outputting audio output signals from a plurality of applications executed by the CPU 11 to the speaker 30.

The first display unit 20a and the second display unit 20b are color display apparatuses each having a display surface formed, for instance, of a liquid-crystal display panel. It is assumed that both the first and second display units 20a, 20b are disposed within the field of view of the driver and within reach from a driver seat. The first and second display units 20a, 20b display images derived from display outputs generated from various applications executed by the CPU 11. The speaker 30 is an output apparatus that outputs audio to a vehicle interior in accordance with audio outputs from various applications executed by the CPU 11.

A software system implemented by the CPU 11 will now be described with reference to FIG. 1B. The CPU 11 functions as a display controller 40 by executing the display control program stored in the storage portion 12.

The display controller 40 is software that provides display control over interrupt screens output from the plurality of applications, which operate independently of each other. In a situation where interrupt screen display requests are generated irregularly and suddenly by a plurality of applications sharing the first display unit 20a and the second display unit 20b, the display controller 40 is capable of performing output arbitration between simultaneously generated interrupt screen display requests. More specifically, the display controller 40 receives interrupt image (or interrupt screen) display requests from the applications and determines the output destination (namely, a particular display unit) for each interrupt image (or interrupt screen) in accordance with output destination priorities (also referred to as output unit priorities) and screen priorities (also referred to as screen display priorities or image display priorities) defined for each interrupt image (or interrupt screen). Then, the display controller 40 outputs image information about each interrupt image to the display control portion 13 in accordance with the determined output destination, and causes the associated display unit to display a relevant interrupt image. Details of the above-mentioned processing sequence will be described later.

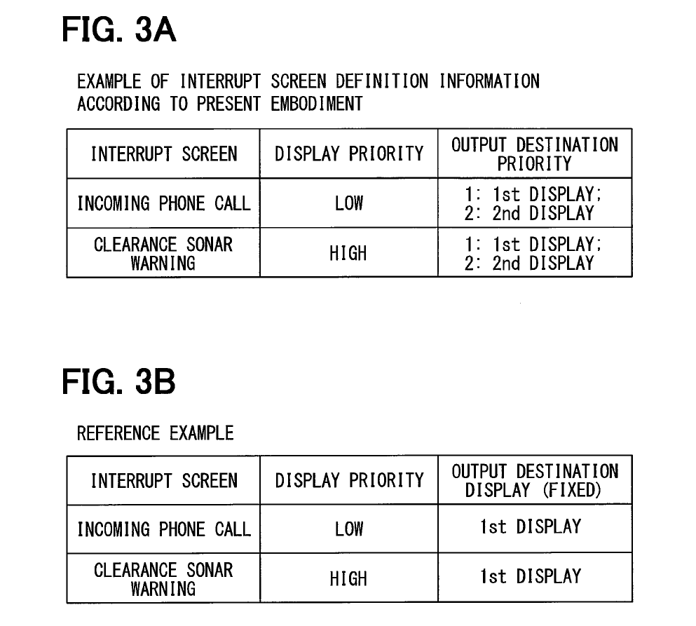

The above-mentioned output destination priorities are handled as information that defines the priorities of display units selectable as an interrupt image output destination for each interrupt image. The screen priorities are handled as information that defines interrupt image display priorities of individual interrupt images. The output destination priorities and screen priorities are stored in the storage portion 12 as interrupt screen definition information (see FIG. 3A).

[Description of Interrupt Screen Display Process]

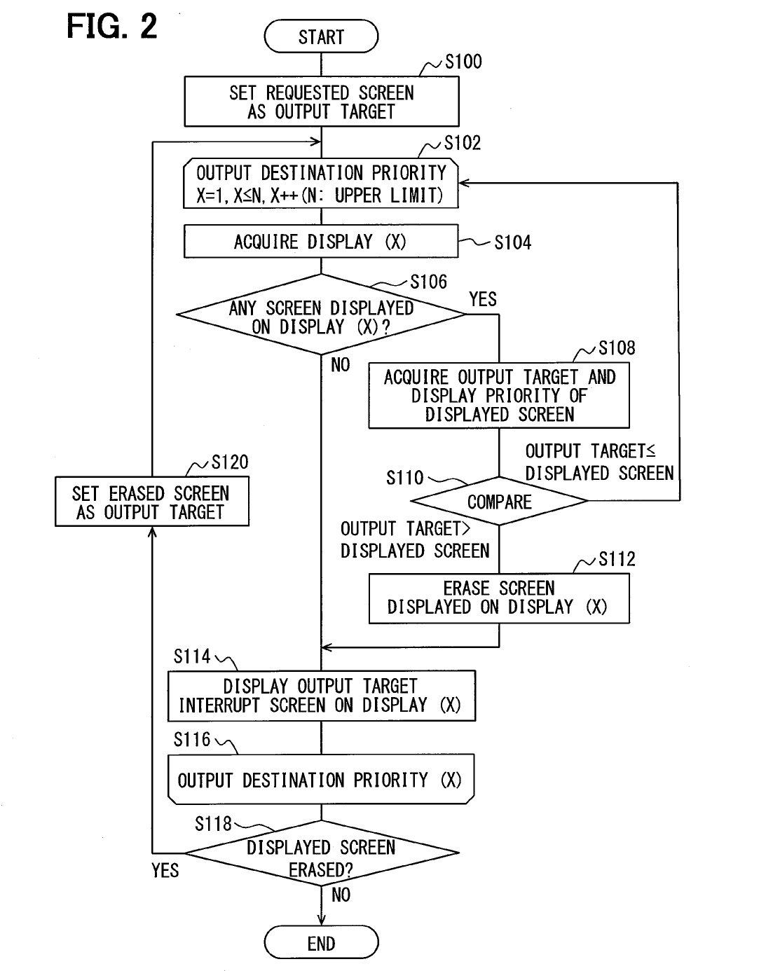

A sequence of an interrupt screen display process performed by the display controller 40 will now be described with reference to the flowchart of FIG. 2. The interrupt screen display process is performed when an application running in the control apparatus 10 generates an interrupt image display request.

It is noted that a flowchart or the processing of the flowchart in the present application includes sections (also referred to as steps), each of which is represented, for instance, as S100. Further, each section can be divided into several sub-sections while several sections can be combined into a single section. Furthermore, each of thus configured sections can be also referred to as a device, module, or means.

Each or any combination of sections explained in the above can be achieved as (i) a software section in combination with a hardware unit (e.g., computer) or (ii) a hardware section, including or not including a function of a related apparatus; furthermore, the hardware section may be constructed inside of a microcomputer.

In S100, the display controller 40 sets an interrupt screen compliant with a newly generated display request as an “output target”. Next, a loop of output destination priorities (X), which is formed of S102 to S116, is initiated for an interrupt screen set as the output target. At first, in S102, the value of a counter X is set. The initial value of the counter X is 1. The value of the counter X is incremented by one each time processing returns to S102. The maximum value of the counter X is an upper-limit value N that represents the maximum number of display units valid as an output destination.

Next, in S104, a display unit that is an output destination having the X-th highest priority (hereinafter referred to as the display unit (X)) is acquired from the output destination priorities of the output target interrupt screen, which are indicated by the interrupt screen definition information. Thus, it can be said that, in 5104, the display controller 40 also functions as an output destination priority acquisition section or an output display unit priority acquisition section. In S106, the display controller 40 determines whether another interrupt screen is displayed on the display unit (X) (this displayed interrupt screen is hereinafter referred to as a displayed screen). If there is a displayed screen on the display unit (X) (if the query in S106 is answered “YES”), processing proceeds to S108. If, on the other hand, there is no displayed screen on the display unit (X) (if the query in S106 is answered “NO”), processing proceeds to S114.

In S114, which is performed when there is no displayed screen on the display unit (X), the display unit (X) displays the output target interrupt screen. Thus, it can be said that, in S114, the display controller 40 also functions as an output instruction section. Next, in S116, the loop of output destination priorities (X) terminates.

Meanwhile, in S108, which is performed when there is a displayed screen on the display unit (X), the screen priorities of the output target interrupt screen and of the displayed screen (currently displayed interrupt screen) are acquired from the interrupt screen definition information. Thus, it can be said that, in S108, the display controller 40 also functions as a screen priority acquisition section or a screen display priority acquisition section. In S110, the display controller 40 compares the screen priority of the output target interrupt screen against the screen priority of the displayed screen. If the result of the comparison indicates that the screen priority of the output target interrupt screen is not higher than the screen priority of the displayed screen (output target displayed screen in S110), processing returns to S102, increments the value of the counter X by one, and repeats the loop of output destination priorities (X).

If, on the other hand, the screen priority of the output target interrupt screen is higher than the screen priority of the displayed screen (output target >displayed screen in S110), processing proceeds to S112. In S112, the display controller 40 erases the displayed screen from the display unit (X) and causes the display unit (X) to display the output target interrupt screen. Next, in S116, the loop of output destination priorities (X) terminates.

After the loop of output destination priorities (X) is terminated, processing proceeds to 5118. In S118, the display controller 40 determines whether the existing displayed screen is erased from the display unit (X) when the display unit (X) displays the output target interrupt screen. This process terminates if the erased displayed screen does not exist when the output target interrupt screen is displayed (if the query in S118 is answered “NO”). If, on the other hand, the erased displayed screen exists when the output target interrupt screen is displayed (if the query in S118 is answered “YES”), processing proceeds to S120. In S120, an interrupt image that is to be transferred and displayed on another display unit, that is, the previously displayed screen that is excluded when the output target interrupt screen is displayed, is set as the next “output target”. The loop of output destination priorities (X), which is performed in S102 to S116, is then executed for the newly set output target interrupt screen to determine the display unit to which the associated interrupt image is to be transferred.

[Concrete Display Example of Interrupt Screen]

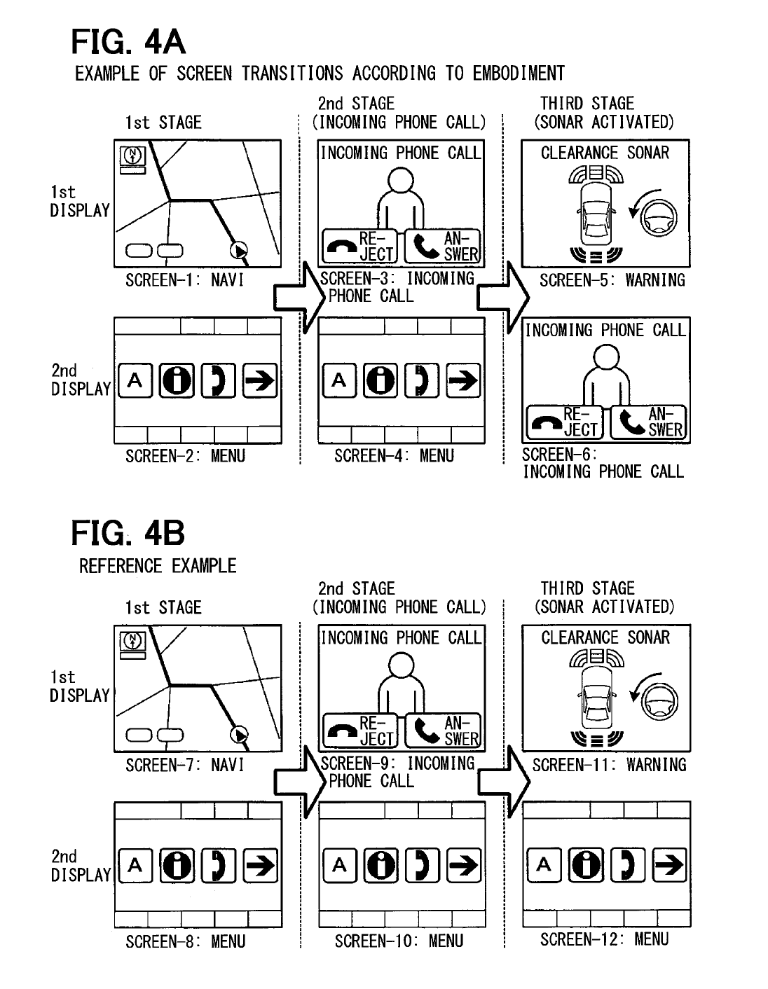

A concrete display example of an interrupt screen that is displayed when the above-described interrupt screen display process is performed will now be described with reference to FIGS. 3 and 4.

An example of interrupt screen definition information is shown in FIG. 3A. This example defines the screen priorities and output destination priorities of an incoming phone call screen, which is an interrupt screen generated by the hands-free phone call application in response to an incoming phone call, and of a clearance sonar warning screen, which is an interrupt screen generated by the clearance sonar application in response to a warning condition. For the incoming phone call screen, a “low” screen priority is defined, the “first display unit (20a)” is defined as a display unit having the highest output destination priority, and the “second display unit (20b)” is defined as a display unit having the second highest output destination priority. For the clearance sonar warning screen, a “high” screen priority is defined, the “first display unit (20a)” is defined as a display unit having the highest output destination priority, and the “second display unit (20b)” is defined as a display unit having the second highest output destination priority.

The output destination priorities of individual interrupt screens may be defined by checking the features and properties of the screens and determining what display unit produces the highest effect. For example, a function specific to a vehicle-mounted instrument, such as a clearance sonar or a millimeter-wave radar, is executed to generate a collision/contact warning screen. This type of warning screen (that is, a warning type screen) needs to be displayed in such a manner that the screen is easily viewable by the driver. Let us assume, for instance, that three display units are mounted in a vehicle. In this instance, a first display unit is a large-size main display unit that is mounted on an upper portion of an instrument panel and most easily viewable by the driver. A second display unit is a sub-display unit that is mounted at the center of the instrument panel. A third display unit is a rear-seat display unit. In this case, in consideration of viewability from the driver, the output destination priorities of a warning screen are such that the main display unit has the highest priority and that the sub-display unit has the second highest priority. The rear-seat display unit is excluded from the output destination priorities because the driver cannot view the warning screen even if it is displayed on the rear-seat display unit.

The screen priorities may be defined by determining what interrupt image will provide a great advantage to the user when preferentially displayed in a situation where a plurality of interrupt image display requests are simultaneously generated. In general, warning screens (that is, warning type interrupt screens) have higher screen priorities with respect to the user than multimedia interrupt screens (that is, multimedia type interrupt screens). The reason is that priority is given to the security and safety of the user. Further, the priorities of warning interrupt screens vary with the degree of temporal emergency. If, for instance, a clearance sonar warning screen display request is generated in order to indicate an approaching roadside guardrail due to a meandering of the vehicle while a millimeter-wave radar warning screen is displayed to alert the user to another vehicle 100 m ahead, the later warning screen is considered to have a higher degree of emergency with respect to the user. As described above, it is important that the output destination priorities and screen priorities of interrupt screens be determined in consideration of properties specific to vehicle-mounted instruments in an environment where a plurality of display units are available.

As a target of comparison with the interrupt screen definition information according to the present embodiment, FIG. 3B shows a reference example of a display rule, which is applied when no improvement is made and is not applicable to the present disclosure. In the example shown in FIG. 3B, the screen priorities and output destination display units are defined for an incoming phone call screen displayed as an interrupt screen by the hands-free phone call application in response to an incoming phone call and a clearance sonar warning screen displayed as an interrupt screen by the clearance sonar application in response to a warning condition. The display rule applied when no improvement is made differs from the interrupt screen definition information according to the present embodiment in that the output destination priorities are undefined and that one display unit is predefined as the output destination for each interrupt screen. In the example, the incoming phone call screen is defined so that the screen priority is “low” and that the output destination display unit is the “first display unit”, and the clearance sonar warning screen is defined so that the screen priority is “high” and that the output destination display unit is the “first display unit”.

FIG. 4A shows exemplary screen transitions according to the interrupt screen definition information shown in FIG. 3A.

In an initial state, that is, at a first stage, it is assumed that no application has generated an interrupt screen display request. In a situation where no interrupt screen is displayed, it is assumed that a normal screen other than an emergency interrupt screen, such as a navigation screen and a menu screen, are displayed on the first display unit 20a and the second display unit 20b in accordance with display outputs from the navigation application and the menu application (SCREEN-1 and SCREEN-2).

Next, at a second stage, it is assumed that the display controller 40 has received an interrupt screen display request from the hands-free phone call application because of an incoming phone call. In this instance, the display controller 40 attempts to display an incoming phone call screen compliant with the display request on the first display unit (20a), which has the highest priority, in accordance with the output destination priorities of the incoming phone call screen (see FIG. 3A). As no other interrupt screen is displayed on the first display unit (20a) at the present moment, the display controller 40 displays the incoming phone call screen on the first display unit (20a) without any change (SCREEN-3).

Next, at a third stage, it is assumed that the display controller 40 has received an interrupt screen display request from the clearance sonar application because of a warning condition while the incoming phone call screen is displayed. In this instance, the display controller 40 attempts to display a clearance sonar warning screen compliant with the display request on the first display unit (20a), which has the highest priority, in accordance with the output destination priorities of the clearance sonar warning screen (see FIG. 3A). At the present moment, however, the incoming phone call screen is already displayed on the first display unit (20a) as an interrupt screen.

The display controller 40 then compares the screen priority of the clearance sonar warning screen compliant with the display request against the screen priority of the already displayed incoming phone call screen (see FIG. 3A). Consequently, the display controller 40 causes the first display unit (20a) to display the clearance sonar warning screen, which has a relatively high screen priority (SCREEN-5). Next, the display controller 40 searches for a display unit that displays the incoming phone call screen, which is excluded by the clearance sonar warning screen. In accordance with the output destination priorities of the incoming phone call screen, the display controller 40 attempts to display the incoming phone call screen on the second display unit (20b), which has the second highest priority. As no other interrupt screen is displayed on the second display unit (20b) at the present moment, the display controller 40 displays the incoming phone call screen on the second display unit (20b) without any change (SCREEN-6). In the above-described manner, the incoming phone call screen and the clearance sonar warning screen can be simultaneously displayed.

As a target of comparison with the exemplary screen transitions shown in FIG.

4A, FIG. 4B shows exemplary screen transitions according to the display rule that is applied as shown in FIG. 3B when no improvement is made. The control apparatus 10 according to the present embodiment does not implement operations shown in FIG. 4B.

In an initial state, that is, at a first stage, it is assumed that no application has generated an interrupt screen display request. In a situation where no interrupt screen is displayed, it is assumed, as is the case with the first stage shown in FIG. 4A, that a normal screen other than an emergency interrupt screen, such as a navigation screen and a menu screen, are displayed on the first display unit 20a and the second display unit 20b (SCREEN-7 and SCREEN-8).

Next, at a second stage, it is assumed that a display request for displaying an incoming phone call interrupt screen is generated by the hands-free phone call application. In this instance, the incoming phone call screen compliant with the display request appears on the first display unit in accordance with the output destination display unit for the incoming phone call screen (see FIG. 3B), which is indicated by the display rule (SCREEN-9).

Next, at a third stage, it is assumed that a display request for displaying a warning condition interrupt screen is generated by the clearance sonar application while the incoming phone call screen is displayed. In this instance, an attempt is made to display a clearance sonar warning screen compliant with the display request on the first display unit in accordance with the output destination display unit for the clearance sonar warning screen (see FIG. 3B), which is indicated by the display rule. At the present moment, however, the incoming phone call screen is already displayed on the first display unit as an interrupt screen. Thus, the screen priority (see FIG. 3B) of the clearance sonar warning screen compliant with the display request is compared against the screen priority of the already displayed incoming phone call screen. Then, the clearance sonar warning screen, which has a relatively high screen priority, appears in the foreground of the first display unit 1 (SCREEN-11). Meanwhile, the incoming phone call screen, which has a relatively low screen priority, is hidden because it is overwritten by the clearance sonar warning screen.

As is obvious from the comparison between the examples shown in FIGS. 4A and 4B, output destination flexibility in a situation where a plurality of interrupt screen display requests are simultaneously generated varies depending on whether the output destination can be determined in accordance with the output destination priorities of a plurality of display units, which are predefined for each interrupt screen.

### Advantageous Effect

The control apparatus 10 according to the present embodiment provides the following advantageous effect.

The output destination for an interrupt screen generated by a certain application is not fixed to one display unit, but can be flexibly selected from a plurality of display units, which are candidate output destinations. In this instance, the output destinations at which a plurality of interrupt screens are to be displayed are methodically determined in accordance with the output destination priorities and screen priorities defined for the individual interrupt screens.

More specifically, an interrupt screen can be output to a display unit that is defined for the interrupt screen, has a relatively high output destination priority, and is not displaying any other interrupt screen at the present moment or has a higher screen priority than other currently displayed interrupt screens. In this instance, if a display unit displays a new interrupt screen that excludes a previously displayed interrupt screen, the excluded interrupt screen can be transferred and displayed on a display unit that is defined for the excluded interrupt screen and has a relatively low output destination priority. Adopting the above-described scheme makes it possible to avoid the loss of an opportunity to present information to the user when the simultaneous display of a plurality of interrupt screens is requested. This provides increased convenience to the user.

The foregoing embodiment has been described on the assumption that the control apparatus 10 is connected to two display units, namely, the first display unit 20a and the second display unit 20b. However, the present disclosure is also applicable to a system that includes a larger number of display units. When the present disclosure is applied to such a system, an interrupt screen display destination can be flexibly selected from three or more display units as far as the priorities of the display units are defined in accordance with the output destination priorities defined by the interrupt screen definition information.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

1. A vehicular video control apparatus comprising:
an output instruction section that distributively outputs a plurality of different interrupt screens compliant with display requests from a plurality of parallelly-running applications to a plurality of video display units mounted in a vehicle;
an output destination priority acquisition section that acquires output destination priorities indicative of priorities of the plurality of video display units selectable as output destinations for the interrupt screens; and
a screen priority acquisition section that acquires screen priorities indicative of display priorities defined for the interrupt screens;
wherein, in accordance with the output destination priorities determined by the output destination priorities of the interrupt screens compliant with the display requests and in accordance with the screen priorities of the interrupt screens, the output instruction section selects the video display units as the output destinations for the interrupt screens and outputs the interrupt screens to the selected video display units.

2. The vehicular video control apparatus according to claim 1, wherein:
when a display request for displaying a new interrupt screen is generated from the applications,
the output instruction section selects, from the plurality of video display units,
a video display unit that has a relatively high output destination priority for the new interrupt screen compliant with the display request and is not currently displaying any other interrupt screen or
a video display unit that has a relatively high output destination priority for the new interrupt screen compliant with the display request and has a higher screen priority for the new interrupt screen than a currently displayed interrupt screen, and
the output instruction section exclusively outputs the new interrupt screen to the selected video display unit.

3. The vehicular video control apparatus according to claim 2, wherein:
when the video display unit displays the new interrupt screen by excluding an existing interrupt screen that is previously displayed on the video display unit,
the output instruction section selects, from the plurality of video display units,
a video display unit that has a relatively high output destination priority for the excluded interrupt screen and is not currently displaying any other interrupt screen or
a video display unit that has a relatively high output destination priority for the excluded interrupt screen and has a higher screen priority for the excluded interrupt screen than other a currently displayed interrupt screen, and
the output instruction section exclusively outputs the excluded interrupt screen to the selected video display unit.
